(19) United States
(12) Patent Application Publication
(10) Pub. No.: US 2019/0116807 A1
(43) Pub. Date: Apr. 25, 2019

(54) Apparatus And Method For The Application Of Images To Baked Products And Baked Products Formed Thereby

(71) Applicant: S2 PEG Limited, Walton, Wakefield (GB)

(72) Inventor: Sandeep Sohanpal, Walton, Wakefield (GB)

(21) Appl. No.: 16/094,981

(22) PCT Filed: Apr. 20, 2017
(86) PCT No.: PCT/GB2017/051098

§ 371 Date: Oct. 19, 2018

(30) Foreign Application Priority Data
Apr. 20, 2016 (GB) 1606868.6
Oct. 4, 2016 (GB) 1616840.3

(51) Int. Cl. A21C 15/00; A21D 13/47; A21D 13/22; A21D 13/24; A23P 20/18; B41J 3/407

(52) U.S. Cl. CPC A21C 15/002; A21D 13/47; B41J 3/4073; A21D 13/24; A23P 20/18; A21D 13/22

(57) ABSTRACT

The invention relates to a baked product which is adapted before during and/or after baking to have one or more images on at least one surface thereof. The image can be applied to an external surface or a surface of a portion of the baked product which is formed, typically by cutting. The portions can be reformatted into the baked product shape and packaged as a retail item after the one or more images have been applied thereto and the images are only exposed when the portions are subsequently removed for consumption. The substance used to form the image can be applied using contactless application apparatus.

The invention to which this application relates is to a method and apparatus which provides the ability to apply an image to a baked product surface or a surface of apportion of the baked product. The application also relates to baked products formed thereby.

In particular, although not necessarily exclusively, the invention relates to apparatus and a method which allows the application of one or more images to a surface of the baked product such as an external surface of the same and/or to surface of a portion of the baked product and which surface is exposed by cutting into the baked product to form a portion of the same.

Known methods for application of an image on baked products can typically be placed into a number of categories but in each case the image is typically applied to the external surface of the baked product. A first category is the application of the image by applying the desired image onto a disc of edible material and then adhering the disc with the use of a suitable food based paste to the product, either before the same is baked, or after the baking of the product. Thus, the disc acts, in effect, as a label on which the desired image is carried. Typically therefore the disc is applied to the exterior surface of the baked product so as to provide, for example, the identity of the company which baked the product and/or information relating to one or more ingredients of the baked product. In a variation of this the image can be placed onto, for example, a baking sheet of material and then transferred from the sheet material onto the surface of the baked product as disclosed in WO2017045069.

A second category is to make an impression on an exterior surface of the product before the same is baked. This means that once the product is baked, the impressed image is viewable on an external surface of the baked product.

Both of these categories have significant problems. With regard to the use of a disc, the disc can become detached from the baked product so that, by the time of display of the product for the purposes of purchase, and at which time the image is of most relevance, the disc is no longer part of the baked product. With regard to the category in which the image is applied to the external surface of the product, then, during the baking of the product, the colouring which is used to create the image, can disperse into the baked product such that the image is not clearly discernible by the time the baked product is ready for purchase and so the impact of use of the image is no longer of value. A further problem is that the when the image is transferred via a transfer sheet, the image actually applied to the baked product surface becomes unclear.

A third category of creating the image is to make an indent into a baked product and then perform a further cooking action on the baked product, such as toasting, so that the part of the baked product in which the indent is formed, does not toast to the same extent as the remainder of the product so that there is a discernible change in colour between the indented portion and the remainder of the product. However, this process requires the user of the baked product to perform a further cooking action in order to be able to achieve the desired image. This is undesirable if, for example, the user has only limited time available and/or does not like the form of the product once it has been toasted or otherwise cooked. Furthermore the toasting of the baked product is only appropriate to be used on a limited range of baked products.

A further problem with all known processes is that the application of the image involves some form of contact between the surface of the baked product and application means, whether be printing apparatus, disc application or transfer using sheet material. This represents a hygiene and contamination risk during the manufacture of the baked product and/or to end consumer.

The aim of the present invention is therefore to provide a means of applying and creating an image on a baked product, which allows the same to be provided with the image clearly defined on the product so as to provide entertainment and/or information to the user of the product and, in certain instances, to allow the product to be linked to a licensed product or character.

A further aim is to provide apparatus and a method which allows the creation of the image in a manner which allows the same to be created in relatively high volumes and thereby allow the creation of the image to be performed on a commercial basis and in a manner which allows hygiene and contamination risks to be avoided.

A further aim of the invention is to provide a baked product which has images applied to internal surfaces of the baked product in addition to, or instead of, the external surface.

In a first aspect of the invention, there is provided a baked product which is adapted by applying a predefined pattern to form a viewable image on at least one surface of the baked product or a baked product portion and wherein the image is applied directly onto the said surface by application apparatus.

In one embodiment the image is created, before, during or after the baking of the baked product.

In one embodiment the image is formed by the application of a substance which is applied from an application means which is located at a spaced distance from the said product surface so as to apply the substance onto the said surface in a contactless manner. By contactless is meant that there is not required to be physical contact between the application means of the apparatus and the surface of the baked product in order to apply the substance to the surface.

In one embodiment the application means sprays the substance onto the surface from an application head and the path of the application head is controlled by processing means so as to form the required image. Typically the distance between the said surface and the application head is such as to allow the image to be formed of the desired size whilst preferably maintaining the definition of the image to the required level.

Typically the substance is applied during and/or after the product has been baked so that the substance is transferred onto the baked product in the required pattern configuration to create the image.

In one embodiment the substance is applied to at least one surface of the baked product which is exposed during or after the product has been baked.

In one embodiment the said surface is exposed by cutting into the baked product. In one embodiment the cutting creates a slice of the baked product, such as a slice of bread or cake.

In one embodiment, the image is applied to at least one of two opposing surfaces of the baked product or a portion thereof.

In one embodiment the images are added to the opposing sides of a slice such that when the slice is placed back together to form the baked product shape the said surfaces are hidden from external view of the baked product until the portions are again separated for consumption by the end consumer.

In one embodiment, the image is created on a stamp or a stencil or is designed and stored as software in a processing means which controls the substance application means operation.

In one embodiment the image or images which are created on the baked product relate to a particular licensed product or character.

In another embodiment, the image or images which are created on the baked product includes the identity of the manufacturer of the baked product and/or information relating to the baked product.

In one embodiment, the substance which is used to form the image, is a liquid and, in one embodiment, includes a food colouring and/or fruit or vegetable based substance so as to provide a specific characteristics, such as added vitamins or other supplement and thereby provide an additional health benefit to the person who consumes the baked product with the images applied thereto.

In one embodiment, the image created on the baked product, is also created or linked to, one or more images which are provided on packaging in which the baked product is subsequently wrapped and sold as a retail item.

In one embodiment the image or images which are created are linked to a particular promotion which is related to the sales of the baked product or products at that time.

In one embodiment the image or images which are applied, are applied to a selected number of baked products or portions of baked products and the image indicates that the selected baked product or portion, if present in the retail item purchased by the consumer is a “winning” product or portion for the consumer who can then claim a prize from the manufacturer or promoter.

In one embodiment the image which is applied indicates the particular prize which can be claimed.

In one embodiment the image includes a security code and in one embodiment this allows the prize claim to be verified as authentic.

In one embodiment the said products or portions with an image applied thereto are randomly inserted into retail packs which includes products or portions with no image or a different image applied thereto, thereby allowing the promotion to be a game of chance. In this embodiment the image may be applied directly via a contactless application apparatus or indirectly via contact from a part of the application apparatus.

In one embodiment the image is created by emitting a laser light onto the surface and relatively moving the laser and/or surface to form the image on the surface in the required pattern.

In a further aspect there is provided a baked product having at least one surface to which a substance is applied, said substance providing nutritional benefit to the baked product and/or consumer of the baked product.

In a yet further aspect of the invention there is provided a baked product having at least one surface on which an image is created and wherein the surface is a surface of the baked product which is exposed by cutting into the baked product during or after baking to form the baked product into portions.

In a further aspect there is provided a baked product which is adapted by applying a substance in a predefined pattern on at least one surface of the baked product or a baked product portion to form a viewable image on said surface.

In one embodiment the substance is applied in a liquid or powder form

In one embodiment, once the required images have been applied to the one or more surfaces, the portions are collated and the shape of the baked product is substantially reformed so that the said surfaces are hidden from external view of the baked product.

In whichever embodiment, the baked product is any, or any combination of savoury or sweet products such as bread, bread rolls, sandwich thins, bagels, crumpets, wraps, pies, doughnuts, cakes, cake bats, cupcakes, muffins, buns, pies, cookies, a wrap, cake, rice cakes, biscuits, crackers, wafers, potato chips or the like and/or a portion thereof such as a slice of bread, cake or the like.

In a further aspect of the invention there is provided apparatus to form one or more images on one or more surfaces of a baked product, said apparatus including one or more application means mounted so as to enable the one or more images to be formed directly on the said surface.

In one embodiment a substance is applied to the surface to create the one or more images. Alternatively a laser is used to create the image.

Preferably the substance is applied in a contactless manner so that it is only the applied substance which contacts the surface in a predefined manner and not the apparatus application means. The use of a non-contact application means such as a spray for the substance means that the opportunity for contamination or hygiene issues being caused by the application apparatus is significantly reduced.

In one embodiment a plurality of the substance application means are provided as part of the apparatus to thereby allow the application of a plurality of images to the surfaces of a plurality of baked products, and/or baked product portion surfaces, simultaneously.

In one embodiment, the apparatus includes means for cutting the baked product to form the portions and expose at least one surface of at least one of the portions onto which the image is to be applied.

In one embodiment the apparatus includes collating means such that once the image or images have been applied to the desired number of surfaces of the baked product portions, the portions are collated back into the baked product shape and/or to collate a plurality of baked products for form a retail item for subsequent purchase, such as for example to provide the required number of slices to form a loaf of bread or to collate a number of biscuits to form a pack of biscuits.

Typically the apparatus includes packaging means in which the said baked product and/or baked products with the one or more images applied thereto is placed into packaging in which the same is to be sold.

In one embodiment the spraying of the substance onto the baked product surface is used to apply the image.

In one embodiment the apparatus can apply images to up to 1500 baked product surfaces per hour.

In an alternative embodiment printing apparatus utilising a sealed pot printing system can be used for the application of the images onto the surface. Alternatively, pad printing apparatus, also called tampography can be used to apply the image to the surface of the slice of bread. This apparatus utilises a printing process that can transfer a 2-D image onto a 3-D object. This is accomplished using an indirect offset (gravure) printing process, involving a silicon pad and a photopolymer plate stencil. In one embodiment the stencil has the image applied thereto by etching utilising a process called post curing.

In a further aspect of the invention, there is provided a method of creating at least one image on a surface of a baked product or of a portion thereof, said method comprising the steps of defining a pattern of the desired image, selecting one or more surfaces of the product onto which the one or more images are to be created, providing an application means to be used to form the image directly on the surface in the required pattern so as to form the image on the one or more surfaces.

In one embodiment the same substance may be used for each part of the image and/or each image. Alternatively different substances are applied for different images and/or different parts of the same image so as to form the particular desired visual and/or edible effect.

In one embodiment the difference in the substances may be to provide different colours and/or tactile effects.

In another embodiment the difference in the substances may be to provide particular edible effects such as, for example, to provide vitamins and/or other health supplements which are beneficial to the consumer of the baked product.

In one embodiment the substance is applied using a contactless technique in which the application apparatus does not contact the said surface.

In one embodiment the substance is applied by spraying.

In one embodiment, the method includes the step of cutting the baked product so as to create portions of the baked product and hence expose a surface on which the image is to be applied.

In one embodiment, the cutting process has the effect of cutting the baked product into slices.

In one embodiment the said image is applied to an external surface of the baked product and/or the same or another image is applied to a alternatively to a surface of the baked product which is exposed by cutting into the baked product to form the same into portions and the said surface or surfaces to which the image is applied is at least one of the newly exposed surfaces.

In one embodiment the method includes the step of collating portions of a baked product together, and/or baked products together which have had at least one image applied thereto so as to form a retail pack with outer packaging.

In a further aspect of the invention there is provided a baked product having at least a surface to which a substance is applied, said substance providing nutritional benefit to the baked product and/or consumer of the baked product.

Specific embodiments of the invention are now described with reference to the accompanying drawings wherein;

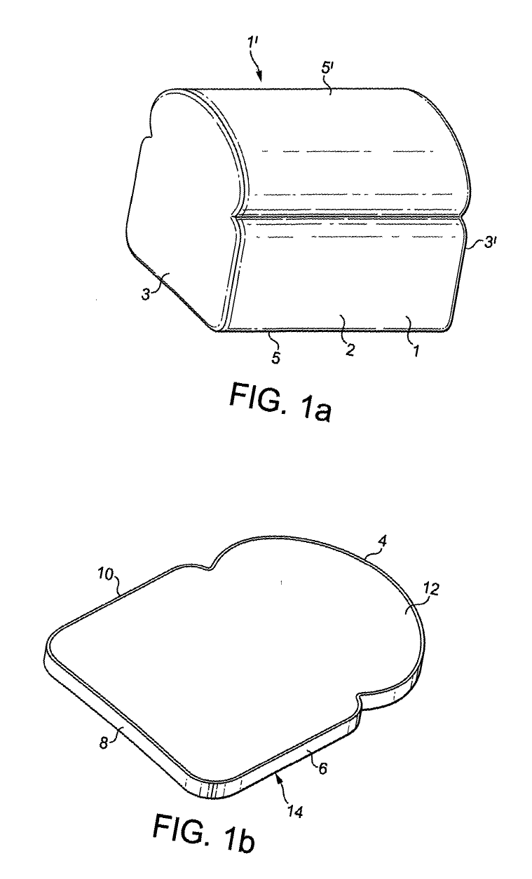

FIG. 1a illustrates a baked product in the form of a bread loaf;

FIG. 1b illustrates a slice of the bread loaf with a surface to which an image in accordance with the invention is applied in accordance with one embodiment of the invention;

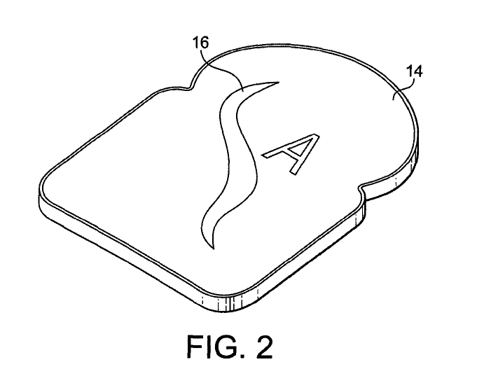

FIG. 2 illustrates the slice of bread of FIG. 1b with the image applied to a surface thereof;

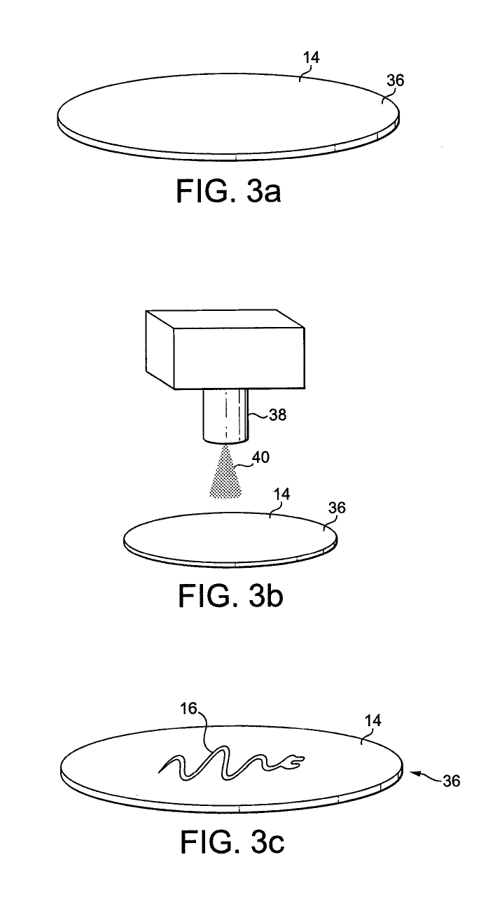

FIGS. 3 (a) to (c) illustrate in a schematic manner, apparatus and method for the application of the images to a plurality of slices of bread simultaneously in accordance with one embodiment of the invention;

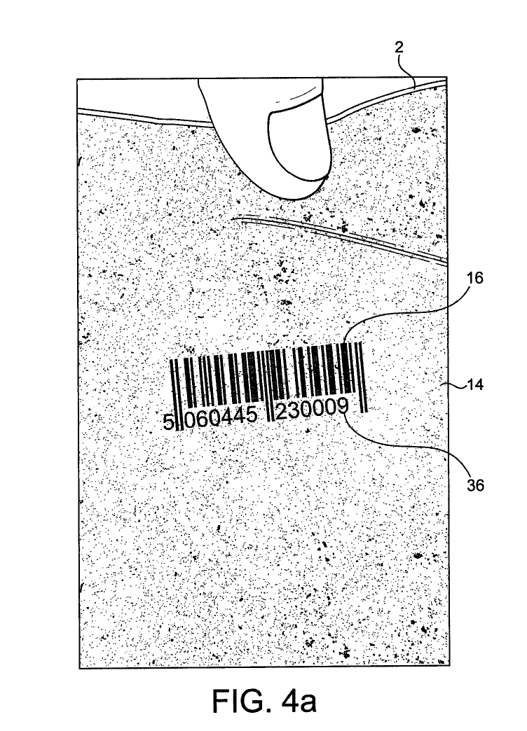

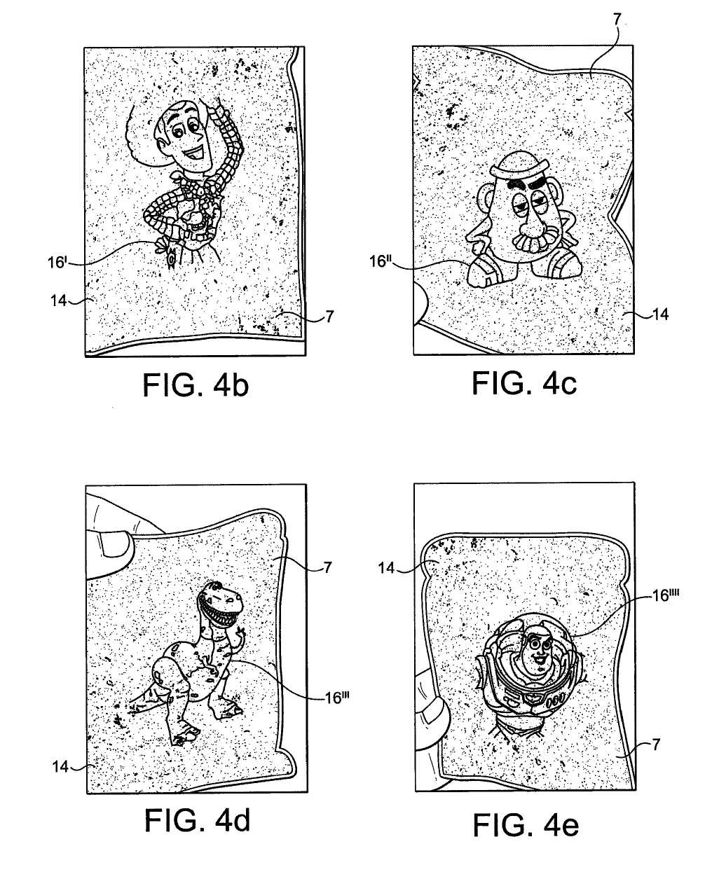

FIGS. 4a-e illustrate portions of a baked product with a surface onto which an image has been applied in accordance with the invention;

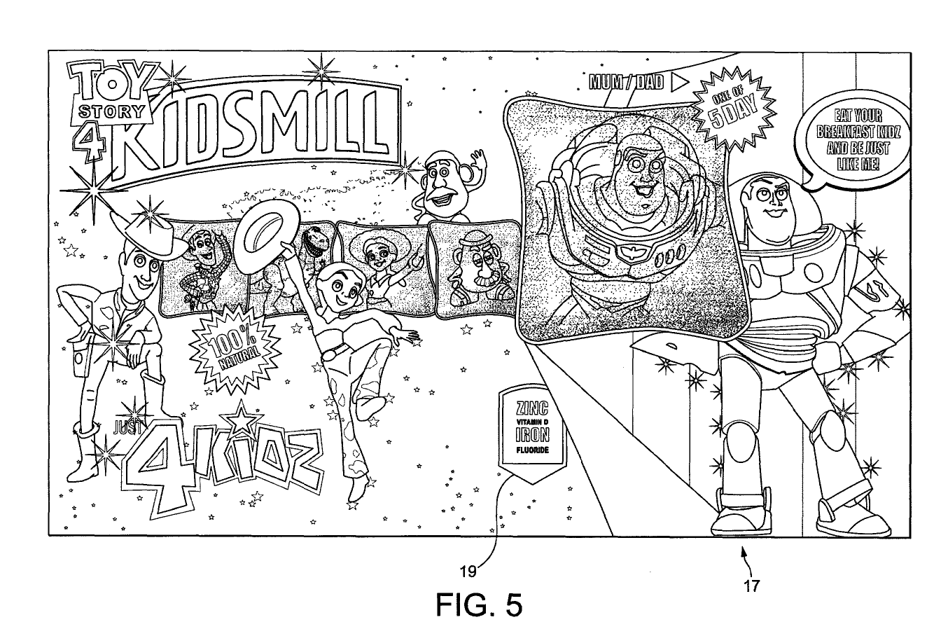

FIG. 5 illustrates the manner in which the baked product packaging and images applied to the baked product itself can be linked;

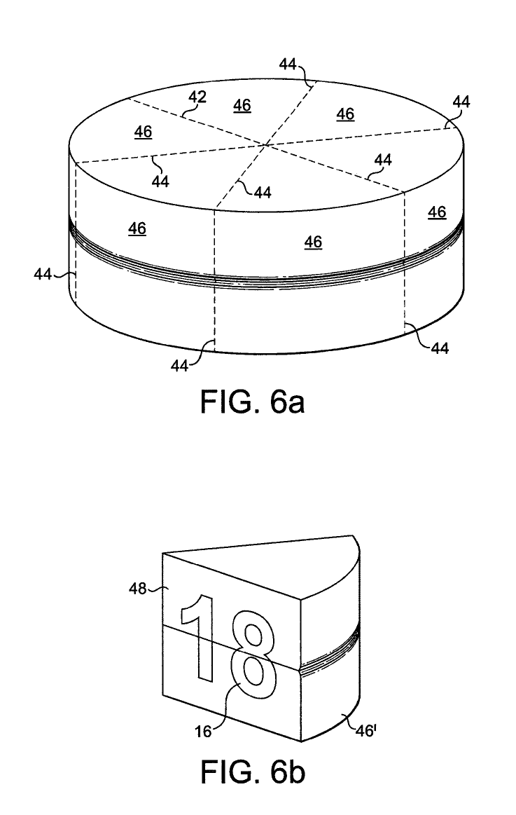

FIGS. 6a-8 illustrate other baked products and portions in accordance with embodiments of the invention; and

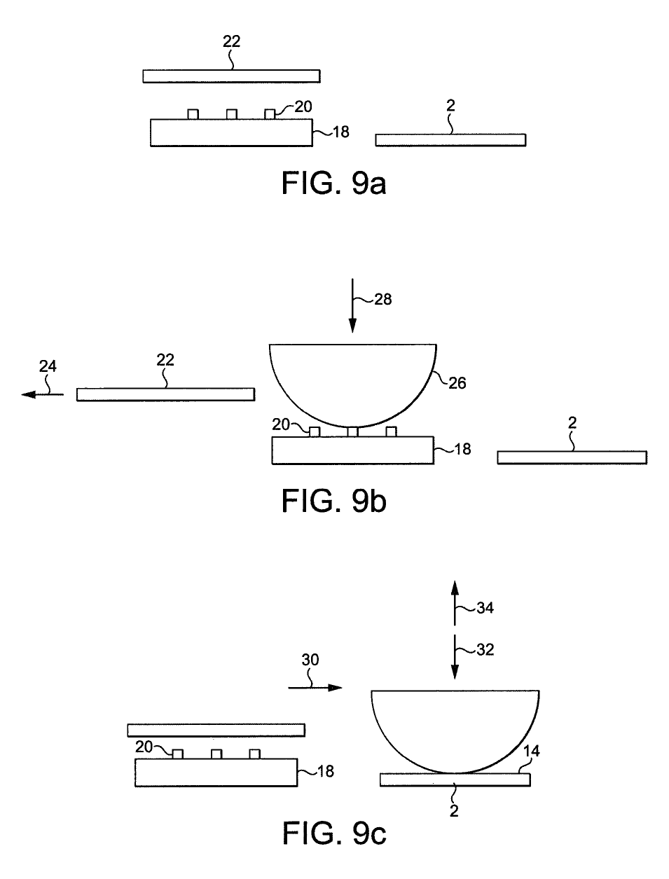

FIGS. 9(a) to (c) illustrate in a schematic manner, apparatus and method for the application of the images to a plurality of slices of bread simultaneously in accordance with another embodiment of the invention

Referring firstly to FIG. 1a, there is illustrated a baked product 2 which in this case is in the form of a loaf of bread but which could also be any other form of baked product such as those mentioned previously. The bread loaf 2 has side surfaces 1, 1′, end surfaces 3,3′ and top and bottom surfaces 5,5′ and in one embodiment the image can be applied to these surfaces in the manner subsequently described.

In addition, or alternatively, one or more images can be applied to a surface or surfaces of a portion of the baked product such as a surface which is exposed during the baking process or after the baking has been performed. The portions can be created by cutting into the baked product and so exposing the surfaces of the portion. In FIG. 1b the baked load is shown as having been cut to form a portion in the form of a slice of bread 7 which has been cut from the loaf of bread 2 of FIG. 1a. The slice 7 has side edges 4,6,8 and 10 and opposing surfaces 12 and 14. In this case the slice 7 is formed by cutting the loaf of bread 2 once the bread has been baked but typically at or prior to the loaf of bread leaving the bakery apparatus.

In accordance with the invention, an image 16 is applied to the surface 12 or 14, or perhaps both surfaces, of the portion 7 so as to provide a decorative and/or informative image on the same. One example of a decorative image 16, is shown in FIG. 2 in which the same has been applied to the surface 14 and it is shown how a clear and distinguishable image is formed on the surface of the slice of bread. The same or different images can be applied to surfaces of further portions or slices of the baked product 2. Once the required images have been applied to the required number of surfaces, the slices or portions can, in one embodiment, be collated back together to reform the shape of the loaf of bread 2 which, in one embodiment is then packaged in outer sheet packaging and then made available for purchase as a retail pack. In a similar manner a number of baked products which include at least one product with a surface with an image applied thereto, can be collated and enclosed in an outer package to form a retail pack such as for example, a number of biscuits, rice cakes, wraps, sandwich thins or the like

As illustrated in FIGS. 4b-e, the images 16 which are applied to the one or more surfaces 14 of a portion 7 of a baked product may, in one embodiment be a range of images 16′-16″″ which are interlinked such as, in this example, a range of cartoon characters linked to a common theme, a particular movie, in this case Toy Story, a particular band or the like and therefore provide a surprise element when the surfaces which are hidden when the baked product is bought as a retail item and during consumption, are exposed when portions of the baked product are removed for consumption and the surface with the image thereon is exposed to show a particular image. In one embodiment the baked product is provided as a retail pack in packaging of sheet material 17 as shown in FIG. 5 which is linked to the same theme, the film Toy Story in this example, and so is linked to the images which are applied to the baked product surfaces. This therefore make the retail item more appealing to the purchaser and/or prospective consumer such as parents and children. It is also shown in FIG. 5 how the packaging sheet material may also include ingredient details 19 which can also be included in the substance from which the images are formed and which may be selected to provide particular health benefits.

In another embodiment, the images which are applied may be linked to a particular occasion such as a national occasion, a sporting occasion or to a more specific occasion such as a celebration of a birthday, wedding or the like. It will therefore be appreciated that the selection of the particular images which are applied can be used to personalise the baked product and add value to the same. The image 16 applied can also provide information in relation to the manufacturer, ingredients of the baked product and/or other information, as illustrated in FIG. 4a in which the information is provided in the form of an image of a barcode 36. FIGS. 6a-8 illustrate some further embodiments of use of the invention.

In FIGS. 6a and b there is shown a baked product in the form of a cake 42 which has a number of cutlines 44 formed therein after baking to form a number of preformed portions 46 as shown. At least one of the portions 46′ as shown in FIG. 6b can be removed and an image 16 is applied to the surface 48 thereof as shown, in this case to represent a particular birthday age for the cake, but which equally could be a winning number for a competition and which is concealed at the time of purchase of the cake. The portion 46′ is then replaced back with the other portions 46 to reform the cake as shown in FIG. 6a and the same can then be packaged and sold. Thus it is only when the consumer removes the portion 46′ that the surface 48 and image 16 is exposed and so there is provided a surprise element to the consumer.

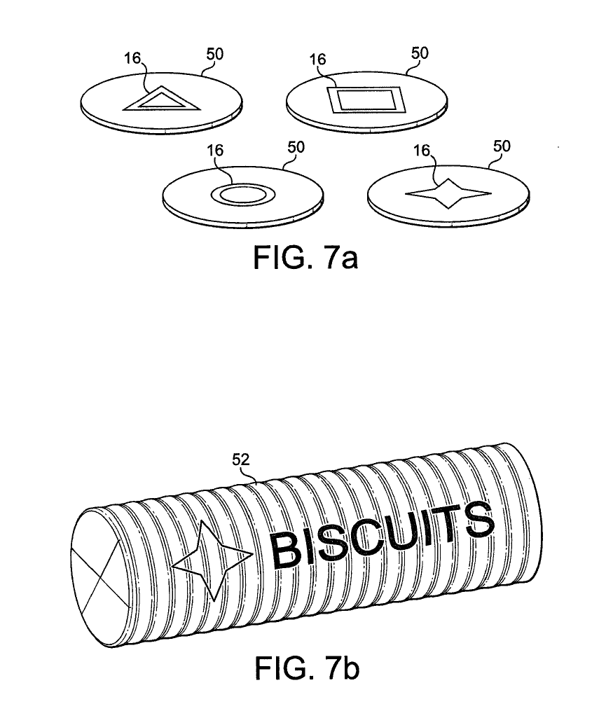

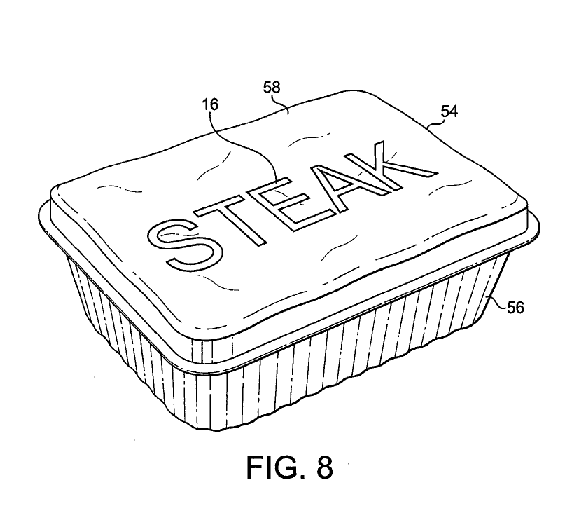

FIGS. 7a and b illustrate a number of baked products 50 in the form of biscuits, some of which are shown separately in FIG. 7a and as part of a pack of biscuits 52 for purchase by a consumer. The biscuits 50 each have an image 16 applied thereto and these can be randomly inserted with other biscuits with other images or no images thereon and to collate and wrap the same with the required number of biscuits to form the pack 52. FIG. 8 illustrates a baked product in the form of a pie 54 which is provided in a case 56 which contains a filling and the top surface 58 of the pie has an image 16 applied thereto. In this case the image is used to indicate the type of filling and hence pie (in this case a steak pie).

FIGS. 3a-c and 9a-c illustrates the steps which can be followed in accordance with the method and apparatus in accordance with embodiments of the invention. In this embodiment the substance used to form the images applied in a liquid form and in one embodiment the substance is an edible ink based substance which may be a hot melt ink which is edible and which can include added ingredients to create the image such as a food colouring to provide a particular colour and/or foods or food extracts which are of nutritional value and/or ingredients such as vitamins to provide health benefits.

It should be appreciated that although the Figures illustrate the application of the pattern onto the surface of one portion such as a slice 7 of a bread loaf 2, the process can be repeated simultaneously at a number of printing stations.

In FIG. 3a the baked product shown is a wrap 36 which has a surface 14 onto which the image 16 is to be applied. In FIG. 3b there is shown on a smaller scale how the wrap 36 is located under and in proximity to an application head 38 for the substance 40 which is to be used to form the image. The substance is applied from the application head in the form of a spray and relative movement between the baked product wrap 36 and the application head 38 allow the substance to be applied to the surface in the required pattern 14 so as to form the image as shown in FIG. 3c. The wrap can then be removed and the next wrap located under the application for the image to be applied thereto and so on.

It is found that a suitable example of application head and application control apparatus is an inkjet hot melt printer, preferably with a large drop volume in order to provide a relatively fast application of the substance and in a non-contact manner thereby reducing any hygiene or contamination issues.

It should also be noted that the application head and application of the substance as shown in FIGS. 3a-c can be substituted by the use of a laser which directs a laser onto the surface to form an image in a predefined pattern. In this case the process would colour the product surface and may be used on the baked product before during or after baking.

In FIGS. 9a-c there is illustrated a contact application technique and the pattern 20 which is to be applied is created on a stamp 18 and, as shown in FIG. 9a the stamp is applied to the pattern 20 from a reservoir 22 which is moved to the position shown in FIG. 9(a). In the contact process the reservoir 22 is removed from the pattern as indicated by arrow 24 in FIG. 9b and this allows a tampo printing pad 26 to be moved downwardly as indicated by arrow 28 to pick up the liquid substance of the pattern 20 from the stamp 18 so that the form of the pattern 20 is now present on the tampo printing pad 20. The tampo printing pad is then raised and moved sideways as indicated by arrow 30 in FIG. 9c to be positioned over the slice of bread 2 with the surface 14 to which the pattern is to be applied, exposed. The tampo printing pad is then moved down as indicated by arrow 32 in FIG. 9c when it overlies the surface 14 of the slice of bread 2 and is moved into contact with the surface 14 and thereby apply the substance with the desired image pattern 20 onto the slice of bread.

Once applied, the tampo printing pad is raised as indicated by arrow 34 and returned to a standby position, the slice of bread with the image pattern 20 thereon is removed and replaced with the next slice of bread and the process repeated from FIG. 9a-c for each slice of bread.

It should also be appreciated that in whichever process is used, different substances and/or different colours of the substance can be applied to provide the image in the required form. It should also be appreciated that other foodstuffs such as sprinkles or the like may be applied as part of the application of the substance.

Thus, in accordance with one embodiment of the invention, there is provided a method in which a portion which has been cut from a baked product can have at least one image applied to at least one surface thereof and, in one embodiment the portion can then be consumed and/or made available for purchase or in another embodiment the portions are then reconfigured with other portions of the baked product to reform the baked product into a form for the application of packaging thereto so that the baked product can then be presented for subsequent purchase and consumption.

Typically the steps of separation of the portions of the baked product and the application of the image is performed as part of the baking process and is therefore suited to be ing performed on a commercial large volume scale.

In one embodiment all, or at least a plurality of portions, of the baked product are separated to allow the application of images to a plurality of surfaces thereof and the same images may be applied to a number of the slices or, alternatively different images are selectively applied.

It should be appreciated that a number of portions of the baked product can be printed simultaneously and the ability to apply the substance directly and/or create the image directly, i.e. without the need to use an intermediate medium, and yet further preferably in a non-contact manner can be used to overcome any hygiene concerns which may exist in relation to contact application processes.

Furthermore, the substance, which can be formed of food extracts and/or foodstuffs which have nutritional benefits allow the baked product with the substance images applied thereto to have added nutritional benefits and so be marketed as having nutritional benefits over and above conventional baked products. For example, the liquid substance may include vegetable extracts which contribute towards the recommended “5-a-day” consumption of vegetables and fruit. The fact the liquid is applied as a pattern which is attractive to children therefore increases the chances of successfully increasing the provision of nutritional benefit to the children, and adults, by consuming the baked products in accordance with the invention. In one embodiment the substance is a food grade ink certified as safe by the appropriate authority such as United States Food and Drug Administration (FDA) and European Union regulations and preferably does not include any substance which may cause allergic reaction to consumers.

1. A food product which is adapted by applying a predefined pattern to form a viewable image on at least one surface of the food product or a food product portion and wherein the image is applied directly onto the said surface by application apparatus.

2. A food product according to claim 1 wherein the viewable image is created by applying a substance from an application means which is located at a spaced distance from the said food product surface so as to apply the substance onto the said at least one surface in a contactless manner.

3. A food product according to claim 2 wherein the substance is sprayed onto the at least one surface from an application head.

4. A food product according to claim 1 wherein the viewable image is created before, during and/or after the food product has been baked.

5. A food product according to claim 1 wherein the said at least one surface or surfaces to which an image is to be applied is/are exposed by cutting into the food product to form the same into portions.

6. A food product according to claim 1 wherein the substance is applied to a surface of the food product which is exposed after the product has been at least partially baked.

7-8. (canceled)

9. A product according to claim 5 wherein once one or more images have been applied to one or more surfaces of one or more portions, the portions are then collated to reform the food product shape.

10. A product according to claim 9 wherein when the food product is reformed the applied images are hidden from external view of the food product.

11. A product according to claim 1 wherein the food product is a baked product in the form selected from the group consisting of: any, or any combination of savoury or sweet products such as bread, bread rolls, sandwich thins, bagels, crumpets, wraps, pies, doughnuts, cakes, cake bars, cupcakes, muffins, buns, pies, cookies, a wrap, bagel, bread rolls, cake, rice cakes, biscuits, crackers, wafers, potato chips or the like and/or a portion thereof such as a slice of bread, and cake.

12. A food product according to claim 1 wherein the at least one image which is created on the said surface relates to a particular licensed product or character.

13. A food product according to claim 1 wherein the viewable image which is created on the said surface includes an identity of a manufacturer of the food product and/or information relating to the food product and/or a retail package including the food product.

14. (canceled)

15. A food product according to claim 1 wherein the substance is selected from the group consisting of: any or any combination of an edible wax, vegetable dye and other ingestible compound.

16. A food product according to claim 1 wherein the substance includes members selected from the group consisting of: a food colouring, fruit or vegetable based substance, health supplement, vitamins so as to provide one or more specific characteristics to the food product.

17. A food product according to claim 16 wherein at least one of the characteristics is such as to provide a health benefit to a consumer.

18. A food product according to claim 1 wherein one or more viewable images created on the baked product, is linked to one or more images which are provided on packaging in which the food product is subsequently sold as a retail item.

19. A food product according to claim 1 wherein the viewable image is created by direction of at least one laser emission onto the said surface.

20. A baked product having at least one surface to which a substance is applied, said substance providing nutritional benefit to the baked product and/or consumer of the baked product.

21-23. (canceled)

24. A baked product according to claim 20 wherein the substance is applied in a liquid or powder form

25. Apparatus to form one or more images on one or more surfaces of a baked product, said apparatus including one or more application means mounted so as to enable the one or more images to be formed directly on the said surface.

26. (canceled)

27. Apparatus according to claim 25 wherein the substance is applied in a contactless manner so that it is only the applied substance which contacts the surface in a predefined manner.

28. (canceled)

29. Apparatus according to claim 25 wherein a plurality of application means are mounted so as to enable the application of a plurality of the images to a plurality of baked product surfaces simultaneously.

30. Apparatus according to claim 25 wherein the apparatus includes means for cutting the baked or partially baked product to form portions thereof and expose at least one surface of a portion onto which the image is to be applied.

31. Apparatus according to claim 25 wherein the apparatus includes collating means such that once the image or images have been applied to the desired number of surfaces of the baked product portions, the portions are collated to substantially reform the baked product.

32. Apparatus according to claim 25 wherein the apparatus includes packaging means in which one or more baked products with the one or more images applied thereto is placed in which the same is to be sold as a retail pack.

33. (canceled)

34. A method of creating at least one image on a surface of a baked product or of a portion thereof, said method comprising the steps of defining a pattern of the desired image, selecting one or more surfaces of the product onto which the one or more images are to be created, providing an application means to be used to form the image directly on the surface in the required pattern so as to form the image on the one or more surfaces.

35. (canceled)

36. A method according to claim 34 wherein different substances are applied for different images and/or different parts of the same image so as to form a particular desired visual and/or edible effect.

37. (canceled)

38. A method according to claim 34 wherein the method includes the step of cutting the baked product so as to expose a surface or surfaces onto which one or more images are to be applied.

39. A method according to claim 34 wherein the method includes the step of collating portions of a baked product together, and/or baked products together which have had at least one image applied thereto so as to form a retail pack with outer packaging.
